(19) United States
(12) Patent Application Publication
(10) Pub. No.: US 2017/0300349 A1
(43) Pub. Date: Oct. 19, 2017

(54) STORAGE OF HYPERVISOR MESSAGES IN NETWORK PACKETS GENERATED BY VIRTUAL MACHINES

(71) Applicant: HEWLETT PACKARD ENTERPRISE DEVELOPMENT LP, Houston, TX (US)

(72) Inventors: Adrian Shaw, Bristol (GB); Chris I Dalton, Bristol (GB)

(73) Assignee: HEWLETT-PACKARD DEVELOPMENT COMPANY LP, Houston, TX (US)

(21) Appl. No.: 15/511,933

(22) PCT Filed: Sep. 26, 2014
(86) PCT No.: PCT/US2014/057907

§ 371 Date: Mar. 16, 2017

(51) Int. Cl. G06F 9/455; H04L 29/06

(52) U.S. Cl. CPC G06F 9/45558; H04L 69/22; G06F 2009/45583; G06F 2009/45595

(57) ABSTRACT

Techniques for storing hypervisor messages in a network packet are described. In one aspect, a hypervisor of a computing device obtains a network packet generated by a virtual machine. The hypervisor may then identify available space within the network packet that can store data relating to a hypervisor message. The hypervisor may then store the hypervisor message in the available space within the network packet. The hypervisor may cause a physical network interface controller to transmit the network packet to a destination device through a network path that includes a message logging device.

### BACKGROUND

One function of an operating system is to interface with physical resources on a computing system. However, sometimes it can be advantageous to run multiple operating systems on the same computing system. In that case, safe operation with the physical resources may be compromised when two operating systems access the same physical resource without coordination of those accesses.

A hypervisor is a software layer that is configured to be interposed between one or more virtual machines and protected physical resources (such as processors, I/O ports, memory, interrupts, etc.). The virtual machines may each execute a different instance of an operating system. The hypervisor functionally multiplexes the protected physical resources for the operating systems, and manifests the resources to each operating system in a virtualized manner. For instance, as a simple example, suppose that there are two operating systems running on a computing system that has one processor and 1 Gigabyte (GB) of Random Access Memory (RAM). The hypervisor may allocate half of the processor cycles to each operating system, and half of the memory (512 Megabytes (MB) of RAM) to each operating system. Furthermore, the hypervisor may provide a virtualized range of RAM addressed to each operating system such that it appears to both operating systems that there is only 512 MB of RAM available.

### BRIEF DESCRIPTION OF DRAWINGS

Examples are described in detail in the following description with reference to examples shown in the following figures:

FIG. 1 illustrates a system configured to embed hypervisor messages in outgoing networking packets originating from virtual machines, according to an example;

FIG. 2 is a flowchart illustrating a method for storing hypervisor messages in virtual machine network traffic, according to an example;

FIG. 3 is a flowchart illustrating a method for identifying available space in a network packet based on a classification type of the network packet, according to an example;

FIG. 4 is a flowchart of a method for extracting hypervisor message from a network packet initiated by a virtual machine, according to an example; and

FIG. 5 is a block diagram of a computing device capable of storing or extracting hypervisor messages in a network packet, according to one example.

### DETAILED DESCRIPTION

Although hypervisors can allow for flexible security management controls on machines belonging to an organization or to an owner of a small business, hypervisors can introduce a number of issues, such as adding performance overhead in network operations. For performance reasons, a virtual machine may be given direct control of the physical network hardware. Such direct control may avoid the performance penalties when the network is fully virtualized. However, the consequence of a virtual machine being in control of the network hardware may be that the hypervisor is unable to use the network card for sending packets. This can be a problem for hypervisors enforcing company policies, which may need to send audit logs or notifications to a remote server. Messages relating to an enforcement of a company policy (e.g., audit logs or notifications) sent by a hypervisor may be referred to as hypervisor messages. Whilst network cards geared towards supporting network virtualization exist, such as single root (SR) input/output virtualization (IOV) compliant network cards, such compliant cards are expensive as they include comparably sophisticated circuitry for virtualizing network communication.

Examples discussed herein present techniques which can address a scenario where a hypervisor of a computing device may communicate with an external computing device (e.g., a server) while still giving the operating system of the computing device substantially direct control of the network card. For example, the hypervisor of the computing device can provide the operating system a shadow network buffer that appears, from the perspective of the operating system, to be the physical network buffer of the network card. The hypervisor may then periodically inspect packets stored in the shadow network buffer for network packets that can be used to store hypervisor messages.

For example, the foregoing may describe a technique where a hypervisor of a computing device obtains a network packet generated by a virtual machine. The hypervisor may then identify available space within the network packet that can store data relating to a hypervisor message. The hypervisor may then store the hypervisor message in the available space within the network packet. The hypervisor may cause a physical network interface controller to transmit the network packet to a destination device through a network path that includes a message logging device.

These and other examples are now described in greater detail.

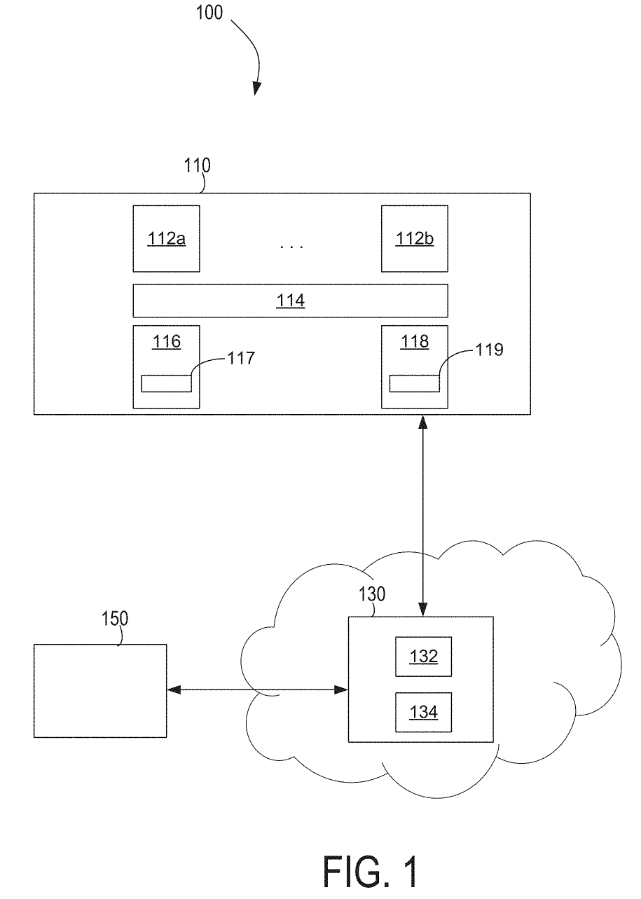

FIG. 1 illustrates a system 100 configured to embed hypervisor messages in outgoing networking packets originating from virtual machines, according to an example. The system 100, as shown in FIG. 1, includes a message embedding device 110, a message logging device 130, and destination device 150. The illustrated layout of the system 100 shown in FIG. 1 is provided merely as an example, and other example systems may take on any other suitable layout or configuration.

The message embedding device 110 may be a computer-implemented device that is configured to embed hypervisor messages in networking packets being sent by a virtual machine. As FIG. 1 shows, the message embedding device 110 may include virtual machines 112a, b, a hypervisor 114, a network interface controller wrapper 116, and a physical network interface controller 118.

Each of the virtual machines 112a, b, may be a program or operating system that not only exhibits the behavior of a separate computer, but is also capable of performing tasks such as running applications and programs like a separate computer. A virtual machine, also known as a guest is created within another computing environment, which may be referred to as a “host.” Multiple virtual machines can exist within a single host at one time.

The hypervisor 114 (alternatively referred to as a virtual machine monitor (VMM)) may be processor executable instructions that, when executed by a processor, manage the virtual machines 112a,b. The hypervisor 114 may present the virtual machines 112a,b with a virtual operating platform and manage the execution of the virtual machines 112a,b. Multiple instances of a variety of virtual machines may share the virtualized hardware resources.

The physical network interface controller 118 may include electronic circuitry used to communicate using a specific physical layer and data link layer standard, such as Ethernet, Wi-Fi, Token Ring, or the like. For example, the physical network interface controller may include a physical network buffer 119 used to store network packets that are then transmitted through a network communication protocol.

The network interface controller wrapper 116 may be a processor implemented module that includes a shadow network buffer 117. The shadow network buffer may be a computer readable memory that stores network packets that a network stack of a virtual machine sends for transmitting through a network. For example, when a network stack of a virtual machine initiates transmission of a network packet, the network stack may write the data of the network packet to the shadow buffer. In turn, the hypervisor 114 may inspect the contents of the shadow network buffer to determine whether a hypervisor message may be stored in the network packet. Further, the hypervisor 114 may map network packets in the shadow network buffer to the physical network buffer of the physical network interface controller 118 when the hypervisor 114 determines that the network packet can be transmitted.

Turning now to the message logging device 130, the message logging device 130 may be a network device configured to receive network packets transmitted by the message embedding device 110 to log the hypervisor messages stored in the network packets. As shown in FIG. 1, the message logging device 130 may include a detection module 132 and a data plane module 134. The detection module 132 may be configured to detect whether a network packet includes a hypervisor message and, if so, cause the hypervisor message to be stored. The data plane module 134 may be configured to forward the network packet to the destination device 150 according to a networking protocol.

The destination device 150 may be a processor-implemented device that is to receive a network packet based on a network address that corresponds to an address specified by a network packet initiated by one of the virtual machines 112a.

The system 100 may include dedicated communication channels, as well as supporting hardware. In some examples, the system 100 includes one or more wide area networks (WANs) as well as multiple local area networks (LANs). The system 100 may utilize a private network, i.e., the system 100 and interconnections therewith are designed and operated exclusively for a particular company or customer, a public network such as the Internet, or a combination of both.

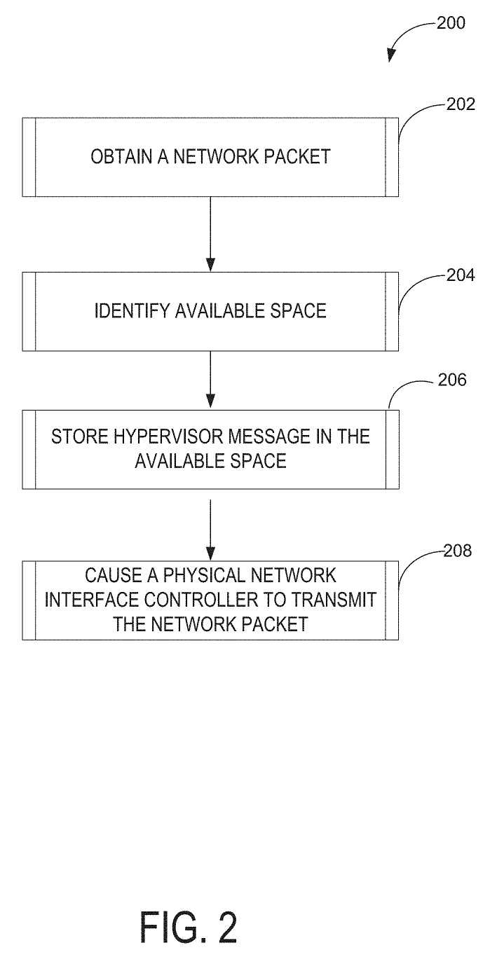

Example operations of the message embedding device 110 is now described in greater detail. For example, FIG. 2 is a flowchart illustrating a method 200 for embedding hypervisor messages in virtual machine network traffic, in accordance with an example. The method 200 may be performed by the modules, logic, components, or systems shown in FIG. 1, such as the modules of a message embedding device, and, accordingly, is described herein merely by way of reference thereto. It is be appreciated, however, that the method 200 may be performed on any suitable hardware.

The method 200 may begin at operation 202 when a hypervisor of a computing device obtains a network packet initiated by a virtual machine of the computing device. In some cases, operation 202 may occur responsive to a network stack operating within the virtual machine sending the network packet to the shadow network buffer. For example, storing the network packet in the shadow network buffer may trigger an interrupt which is mapped to an interrupt handler of the hypervisor. In other cases, the hypervisor may read network packets stored in the shadow network buffer based on a periodic interrupt or an interrupt triggered when the hypervisor has a hypervisor message to send.

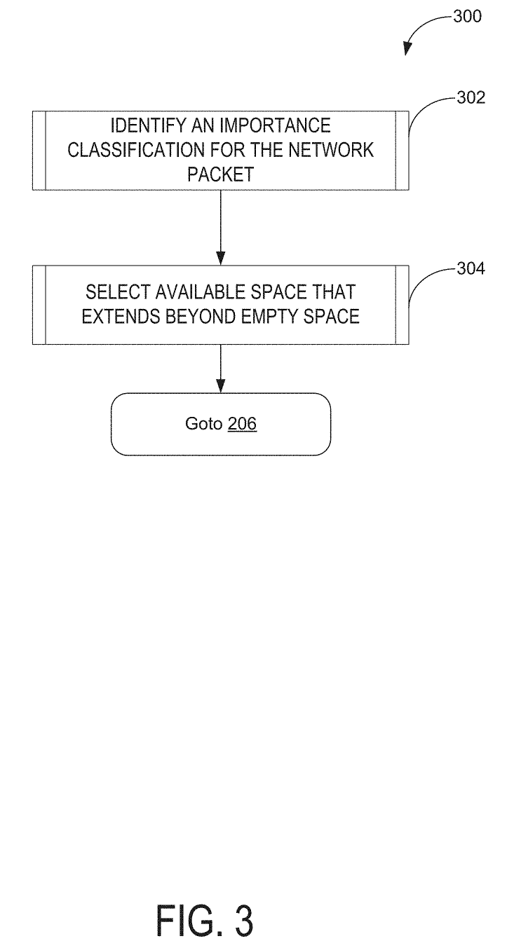

At operation 204, the hypervisor may identify available space within the network packet that can store data relating to the hypervisor message. In some cases, a network packet can store data relating to the hypervisor message if the network packet includes empty space. Thus, operation 204 may involve the hypervisor searching for empty space at the end of the network packet. Such a search may be performed using a byte matching algorithm, such as matching bytes of zeroes in the payload of the network packet. Other approaches for identifying available space is discussed below, with reference to FIG. 3.

At operation 206, the hypervisor may store the hypervisor message in the available space within the network packet. The operation of embedding the hypervisor message may involve the hypervisor inserting magic markers into the available space of the network packet and inserting the hypervisor message in between the magic markers. Additionally, the hypervisor may update the network packet so that the headers include appropriate data in light of the embedded hypervisor message. For example, the hypervisor may re-compute a data checksum and insert the recomputed data checksum in the header of the network packet. Re-computing the checksum may be performed by software (e.g., instructions executed by a processor) or through hardware capabilities exposed by a network card. It is to be appropriated that the operation of inserting data (e.g., hypervisor message, magic markers, or data checksum) may involve overwriting the data originally stored in the available space with the data.

The hypervisor message may include data derived from data collected according to a company policy. An audit log is an example of the type of data that may be transmitted in a hypervisor message.

At operation 208, the hypervisor may cause a physical network interface controller to transmit the network packet to a destination device through a network path that includes a message logging device. For example, the hypervisor may remap the network packet to the physical hardware buffer of the network interface controller. In this way, the operating system driver may proceed with transmitting the network packet. It is to be appreciated that remapping the network packet may involve popping the network packet off the shadow network buffer and pushing the network packet onto the physical network buffer.

As discussed above, with reference to operation 204, the hypervisor may identify available space within a network packet by, for example, searching for a string of bytes with a value of 0. However, in some cases, the hypervisor may identify available space using other techniques. For example, FIG. 3 is a flowchart illustrating a method 300 for identifying available space in a network packet based on a classification type of the network packet, in accordance with an example. Similar to the method 200 of FIG. 2, the method 300 may be performed by the modules, logic, components, or systems shown in FIG. 1, such as the modules of a message embedding device, and, accordingly, is described herein merely by way of reference thereto. It is be appreciated, however, that the method 300 may be performed on any suitable hardware.

The method 300 may begin at operation 302 when a hypervisor of a computing device identifies an importance classification for the network packet. An importance classification may be a classification of a network packet based on the impact of dropping the network packet may have a system (e.g., the sender or receiver of the network packet). For example, if dropping a network packet has a comparable negative effect on a system then that network packet may be classified as a critical network packet. For example, a user datagram protocol (UDP) stream of video packets may be part of a video call, and interfering with that will cause unpleasant jitter in call quality because packets from this type of stream may have higher real-time requirements. However, if dropping a network packet has a comparable negligible effect on a system then that network packet may be classified as an unimportant network packet. By way of example and not limitation, an acknowledgement (ACK) network packet, a TCP/IP SYN message, or any other suitable message used in a protocol for establishing a network connection or domain name system (DNS) information may be classified as a non-critical network packet because, if those messages were dropped, the system would simply resend those messages.

To identify the classification of the network packet, the hypervisor may perform byte matching within the header and/or payload of the network packet to determine the importance classification of the network packet. The byte pattern searched by the hypervisor may be a hardcoded/hardwired byte pattern or a configurable byte pattern that may be programmed by an end-user.

At operation 304, based on the identified importance classification of the network packet, the hypervisor may select the available space to include space within the network packet that extends beyond an empty space. For example, in some cases, the hypervisor may select the whole packet as being available for embedding the hypervisor message. In some cases, selecting the whole packet as being available may conceptually cause the network packet to be dropped (e.g., not reach or otherwise be delivered to the original sender) because the content of the message is not delivered to the destination. However, this may be tolerable because the network packet has been identified as a non-critical. For example, the virtual machine may re-send the network packet after a threshold period of time or after receiving an indication from the destination network device that the network packet was not received.

The method 300 may then continue to operation 206, which is described above with reference to FIG. 2. That is, in some cases, the hypervisor may store a hypervisor message in a network packet from the available space selected at operation 304.

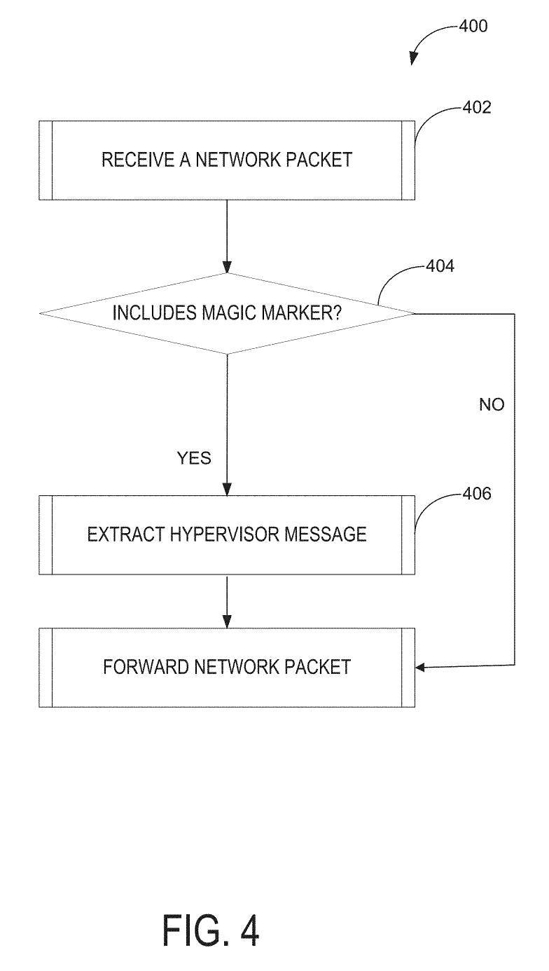

In some cases, the system 100 of FIG. 1 may include mechanisms for extracting the hypervisor message from the network packet before the network packet is delivered to the destination computing device. FIG. 4 is a flowchart of a method 400 for extracting hypervisor message from a network packet initiated by a virtual machine, according to an example. The method 400 may be performed by the modules, logic, components, or systems shown in FIG. 1, such as the modules of a message logging device, and, accordingly, is described herein merely by way of reference thereto. It is be appreciated, however, that the method 400 may be performed on any suitable hardware.

The method 400 may begin at operation 402 when a detection module of a message logging device receives a network packet. In some cases, the detection module may receive the network packet via a virtual private network (VPN) connection between the message logging device and the message embedding device. In other cases, the message logging device may be a network device of a software defined network (e.g., a switch device or a controller) that forms a path between the message embedding device and the message logging device. A software defined network approach may be useful, for example, when the message embedding device is within an enterprise network.

At decision 404, the detection module may determine that the network packet includes a magic marker. The detection module may determine that the network packet includes a magic marker by performing a byte comparison on the header or payload of the network packet to identify portions of the network packet that match the magic marker.

At operation 406, if the detection module determines that the network packet include a magic marker, the detection module may extract the hypervisor message stored between the magic maker and an endpoint. An endpoint may be another magic marker or the end of the network packet. The data extracted from the space between the magic marker and the endpoint is the hypervisor message.

The hypervisor message may then be stored and/or sent to a centralized management server for further analysis or processing, as may be determined by management rules dictated by a given enterprise. In some cases, after the hypervisor message is extracted, the detection module may zero out the space within the network packet that stores the magic marker and the hypervisor message. Further, the header (e.g., a checksum field) of the network packet may be updated to reflect the payload with the zeroed out space.

At operation 408, the data plane module forwards the network packet through the network so that the network packet can be delivered to the destination device.

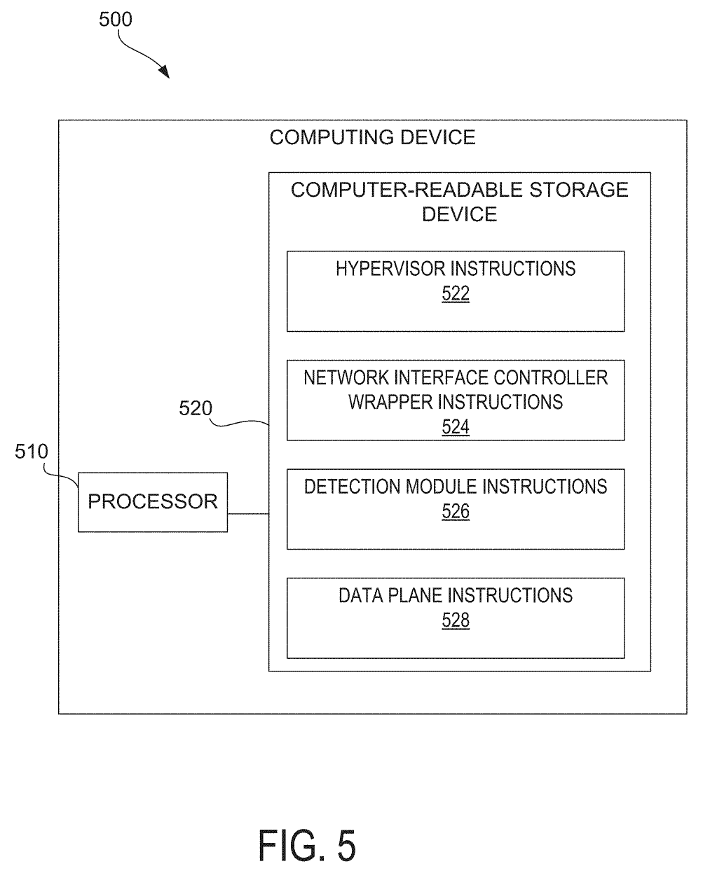

FIG. 5 is a block diagram of a computing device capable of storing or extracting hypervisor messages in a network packet, according to one example. The computing device 500 includes, for example, a processor 510, and a computer-readable storage device 520 including instructions 522, 524, 526, 528. The computing device 500 may be, for example, a security appliance, a computer, a workstation, a server, a notebook computer, or any other suitable computing device capable of providing the functionality described herein.

The processor 510 may be, at least one central processing unit (CPU), at least one semiconductor-based microprocessor, at least one graphics processing unit (GPU), other hardware devices suitable for retrieval and execution of instructions stored in computer-readable storage device 520, or combinations thereof. For example, the processor 510 may include multiple cores on a chip, include multiple cores across multiple chips, multiple cores across multiple devices, or combinations thereof. The processor 510 may fetch, decode, and execute one or more of the instructions 522, 524, 526, 528 to implement methods and operations discussed above, with reference to FIGS. 1-4. As an alternative or in addition to retrieving and executing instructions, processor 510 may include at least one integrated circuit (IC), other control logic, other electronic circuits, or combinations thereof that include a number of electronic components for performing the functionality of instructions 522, 524, 526, 528.

Computer-readable storage device 520 may be any electronic, magnetic, optical, or other physical storage device that contains or stores executable instructions. Thus, computer-readable storage device may be, for example, Random Access Memory (RAM), an Electrically Erasable Programmable Read-Only Memory (EEPROM), a storage drive, a Compact Disc Read Only Memory (CD-ROM), and the like. As such, the machine-readable storage device can be non-transitory. As described in detail herein, computer-readable storage device 520 may be encoded with a series of executable instructions for storing or extracting hypervisor messages in a network packet.

As used herein, the term “computer system” may refer to one or more computing devices, such as the computing device 500 shown in FIG. 5. Further, the terms “couple,” “couples,” “communicatively couple,” or “communicatively coupled” is intended to mean either an indirect or direct connection. Thus, if a first device, module, or engine couples to a second device, module, or engine, that connection may be through a direct connection, or through an indirect connection via other devices, modules, or engines and connections. In the case of electrical connections, such coupling may be direct, indirect, through an optical connection, or through a wireless electrical connection.

What is claimed is:

1. A method comprising:
obtaining, by a hypervisor of a computing device, a network packet generated by a virtual machine executing on the computing device;
identifying, by the hypervisor of the computing device, available space within the network packet that can store data relating to a hypervisor message;
storing, by the hypervisor of the computing device, the hypervisor message in the available space within the network packet; and
causing, by the hypervisor of the computing device, a physical network interface controller to transmit the network packet to a destination device through a network path that includes a message logging device.

2. The method of claim 1, wherein identifying the available space within the network packet includes performing a byte matching search for empty space.

3. The method of claim 1, wherein identifying the available space and storing the hypervisor message is responsive to determining that the hypervisor message is pending.

4. The method of claim 1, wherein storing the hypervisor message in the available space within the network packet includes inserting a magic marker in the available space.

5. The method of claim 1, wherein storing the hypervisor message in the available space within the network packet includes inserting magic markers in the available space and inserting a hypervisor message between the magic markers.

6. The method of claim 1, wherein identifying the available space within the network packet comprises:
determining an importance classification corresponding to the network packet; and
based on the importance classification of the network packet, selecting locations of the network packet that include non-empty space.

7. The method of claim 6, wherein determining the importance classification of the network packet include determining whether the network packet is a message in a connection handshake protocol.

8. A system comprising:
a physical network buffer;
a shadow network buffer to store a network packet generated by a virtual machine; and
a processor to:
identify available space within the network packet that can store data relating to a hypervisor message,
store the hypervisor message in the available space within the network packet, and
remap the network packet to the physical network buffer to initiate network transmission of the network packet.

9. The system of claim 8, wherein the processor is to further recalculate header data of the network packet after the hypervisor messaged is stored.

10. The system of claim 8, wherein the hypervisor message includes data pertaining to an audit log.

11. The system of claim 8, wherein the processor is further to generate the hypervisor message from data collected according to a company policy.

12. The system of claim 8, wherein the processor is further to link the shadow network buffer with a network stack on the virtual machine.

13. The system of claim 8, wherein the processor is further to:
determine an importance classification of the network packet; and
based on the importance classification of the network packet, select locations of the network packet that includes non-empty space.

14. The method of claim 13, wherein the processor is to determine the importance classification of the network packet by determining whether the network packet is a message in a connection handshake protocol.

15. A system comprising:
a processor to:
receive a network packet sent over a network path generated by a virtual machine execution on a computing device;
determine whether a magic marker is stored in the network packet; and
based a determination that the magic marker is stored in the network packet, extract a hypervisor message from the network packet; and
forward the network packet, with the hypervisor message extracted out, to a next network device along a network path leading to a destination computing device.
